(19) United States
(12) Patent Application Publication
(10) Pub. No.: US 2015/0036801 A1
(43) Pub. Date: Feb. 5, 2015

(54) RADIATION GENERATING APPARATUS AND RADIATION IMAGING SYSTEM

(71) Applicant: CANON KABUSHIKI KAISHA, Tokyo (JP)

(72) Inventors: Yasuo Ohashi, Kawasaki-shi (JP); Yoichi Ikarashi, Fujisawa-shi (JP); Yoichi Ando, Inagi-shi (JP)

(21) Appl. No.: 14/394,440

(22) PCT Filed: Jun. 11, 2013
(86) PCT No.: PCT/JP2013/066533

§ 371 Date: Oct. 14, 2014

(30) Foreign Application Priority Data
Jun. 12, 2012 (JP) 2012-132870

(51) Int. Cl. G21K 1/04; H05G 1/02; G01N 23/04

(52) U.S. Cl. CPC G21K 1/046; G01N 23/04; H05G 1/02
USPC 378/62; 378/150

(57) ABSTRACT

A radiation generating apparatus 1 comprising a radiation generating unit 2 which emits radiation, and a movable diaphragm unit 3 which is arranged on the radiation generating unit 2, wherein the movable diaphragm unit 3 has restriction blades 18 which adjust a size of a radiation field, a light source 20 which emits visible light, and a reflecting plate 19 which reflects the visible light thereon and transmits the radiation therethrough, and simulatively shows the radiation field in a form of a visible light field by the visible light, wherein the light source 20 can be moved between a first position at which the light source 20 can simulatively show the radiation field by the visible light field, and a second position which is displaced from an irradiation path of the radiation which irradiates the radiation field.

### TECHNICAL FIELD

The present invention relates to a radiation generating apparatus including a movable diaphragm unit having a function of simulatively showing a radiation field in a form of a visible light field, and a radiation imaging system using the radiation generating apparatus.

### BACKGROUND ART

A radiation generating apparatus usually includes a radiation generating unit having a radiation tube incorporated therein, and a movable diaphragm unit provided on the front face of a radiation transmission window of the radiation generating unit. The movable diaphragm unit has a function of adjusting a radiation field so as to shield a portion that is unnecessary for radiography and reduce an amount of exposure to radiation for a subject, out of the radiation to be emitted through the transmission window. The radiation field is adjusted by adjusting the size of an opening which is formed by restriction blades and transmits the radiation therethrough. In addition, this movable diaphragm unit usually has such a function added as to be capable of simulatively showing the radiation field by a visible light field, and visually confirming a range of the radiation field before radiography.

Conventionally, as a general movable diaphragm unit, the unit as described in Patent Document 1 is known. The movable diaphragm unit described in Patent Document 1 includes a reflecting plate which transmits radiation therethrough and reflects visible light thereon, restriction blades for specifying the radiation field and the visible light field which is formed so as to correspond to the radiation field, and a light source of the visible light. In order not to interfere with the radiation when the radiation has been emitted, the light source is arranged so as to be displaced from an irradiation path through which the radiation irradiates a necessary radiation field. The reflecting plate is arranged diagonally with respect to a center line which is formed by connecting a focus of the radiation with the center of the opening of the restriction blades, so as to be capable of forming a visible light field which simulatively shows the radiation field by reflecting the visible light emitted from the light source which is thus arranged. In addition, the light source and the reflecting plate are both arranged in an envelope having radiation shielding properties, together with the restriction blades.

### CITATION LIST

### Patent Literature

PTL 1: Japanese Patent Application Laid-Open No. H07-148159

### SUMMARY OF INVENTION

### Technical Problem

However, in the above described conventional movable diaphragm unit, the reflecting plate is diagonally arranged therein, and accordingly an envelope that covers the reflecting plate becomes large, which becomes a cause of hindering a downsizing of the radiation generating apparatus and the radiation imaging system using the radiation generating apparatus. In addition, the material which constitutes the envelope and can attenuate the radiation is a material having a large mass, and accordingly there is a problem that the weight results in increasing.

On the other hand, in the above described conventional movable diaphragm unit, when the radiation tube which is provided in the radiation generating apparatus as a supply source for the radiation is a reflecting type radiation tube, there is such an advantage that a heel effect in the reflecting type radiation tube can be reduced by the reflecting plate which has been diagonally arranged. However, when a transmitting type of radiation tube is used, which does not cause the heel effect, there is a problem of rather promoting a distribution of the quality of the radiation.

The present invention is designed with respect to the above described problems, and an object of the present invention is to provide a radiation imaging system having high convenience by reducing the size and weight of the radiation generating apparatus, and to prevent the distribution of the quality of the radiation from increasing when a transmitting type of radiation tube has been used.

### Solution to Problem

In order to achieve the above described object, a radiation generating apparatus of the present invention includes a radiation generating unit which emits radiation, and a movable diaphragm unit which is arranged on the radiation generating unit, wherein the movable diaphragm unit has restriction blades which adjust a size of a radiation field, a light source which emits visible light, and a reflecting plate which reflects the visible light thereon and transmits the radiation therethrough, and simulatively shows the radiation field in a form of a visible light field by the visible light, wherein the light source can be moved between a first position at which the light source can simulatively show the radiation field by the visible light field, and a second position which is displaced from an irradiation path of the radiation which irradiates the radiation field.

Further features of the present invention will become apparent from the following description of exemplary embodiments with reference to the attached drawings.

### ADVANTAGEOUS EFFECTS OF INVENTION

According to the present invention, a reflecting plate in a diaphragm unit can be provided so as to be nearly perpendicular to a center line which connects a focus of radiation with a center of an opening of restriction blades, which is formed when specifying the maximum radiation field. Accordingly, the radiation generating apparatus can reduce its installation area and can store the diaphragm unit in a comparatively small envelope. Accordingly, not only the size and weight of the envelope can be reduced, but also the sizes and weights of the radiation generating apparatus and the radiation imaging system can be reduced. In addition, the radiation generating apparatus resists causing a heel effect when the radiation permeates the reflecting plate, and accordingly can suppress the occurrence of the distribution of the quality of the radiation when a transmitting type of radiation tube has been used.

Further features of the present invention will become apparent from the following description of exemplary embodiments with reference to the attached drawings.

### BRIEF DESCRIPTION OF DRAWINGS

FIG. 1 is a schematic view illustrating one example of a radiation generating apparatus according to the present invention.

FIG. 2A and FIG. 2B are explanatory drawings of a movable diaphragm unit in the radiation generating apparatus of FIG. 1, FIG. 2A is an explanatory drawing which illustrates the time when visible light is emitted, and FIG. 2B is an explanatory drawing which illustrates the time when radiation is emitted.

FIG. 3A and FIG. 3B are explanatory drawings of a second example of the movable diaphragm unit, FIG. 3A is an explanatory drawing in which visible light is emitted, and FIG. 3B is an explanatory drawing in which radiation is emitted.

FIG. 4A and FIG. 4B are explanatory drawings of a third example of the movable diaphragm unit, FIG. 4A is an explanatory drawing which illustrates the time when visible light is emitted, and FIG. 4B is an explanatory drawing which illustrates the time when radiation is emitted.

FIG. 5 is an explanatory drawing illustrating one example of a radiation imaging system according to the present invention.

### DESCRIPTION OF EMBODIMENTS

Exemplary embodiments of the present invention will be described in detail below with reference to the attached drawings. In the following drawings which are referred to, the same reference numerals represent similar components.

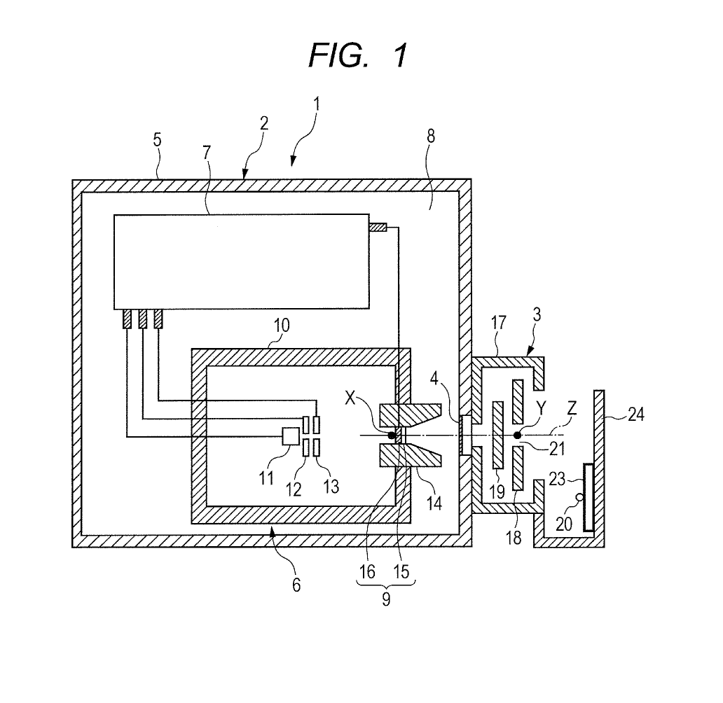

As is illustrated in FIG. 1, a radiation generating apparatus 1 includes a radiation generating unit 2 and a movable diaphragm unit (hereinafter referred to as diaphragm unit) 3.

The radiation generating unit 2 is a unit which emits radiation from a radiation transmission window (hereinafter referred to as transmission window) 4, and stores a radiation tube 6 which is a supply source of radiation, and a driving circuit 7 for controlling this radiation tube 6 in an storage container 5 having this transmission window 4. A surplus space in the inside of the storage container 5 is filled with an insulating liquid 8.

The storage container 5 has desirably a sufficient strength as a container and is desirably excellent in heat dissipation properties, and a metal material, for instance, such as brass, iron and stainless steel can be used as the component material. The insulating liquid 8 is a liquid having electrical insulation properties, and has a role of maintaining electrical insulation properties in the inside of the storage container 5 and has a role as a cooling medium of the radiation tube 6. An electric insulating oil can be used as the insulating liquid 8. A mineral oil, a silicone oil and the like can be used as the electric insulating oil, for instance. The insulating liquid 8 to be used other than the above oils includes an electrically insulating fluorine-series liquid.

The radiation tube 6 in the present example is a transmitting type of radiation tube, and includes a vacuum chamber 10 having a target 9 mounted on a window part, and a cathode 11, a grid electrode 12 and a lens electrode 13 which are arranged in the inside of this vacuum chamber 10. In addition, a shielding member 14 is provided so as to surround the periphery of the target 9, and can shield surplus radiation.

The target 9 is a member having a target layer 16 for generating radiation by being irradiated with electrons provided on a supporting substrate 15 which has adequate transmissivity for radiation, and is mounted so that a side on which the target layer 16 is attached faces to the inner side. Tungsten, tantalum and molybdenum, for instance, are used as the target layer 16. This target layer 16 is electrically connected to the driving circuit 7, and constitutes a part of an anode.

The trunk of the vacuum chamber 10 is formed of an insulating tube which is formed from an insulating material such as glass and a ceramic material, in order that the vacuum chamber 10 keeps the inside at a vacuum and also electrically insulates the cathode 11 from the anode which includes the target layer 16. The inside of the vacuum chamber 10 is decompressed so as to make the cathode 11 function as an electron source. The degree of vacuum can be approximately 10⁻⁴ Pa to 10⁻⁸ Pa. The vacuum chamber 10 is provided with a not-shown exhaust pipe, and the inside of the vacuum chamber 10 can be exhausted through this exhaust pipe. When the exhaust pipe is used, if a part of the exhaust pipe has been sealed, after the inside of the vacuum chamber 10 has been evacuated through the exhaust pipe, the inside of the vacuum chamber 10 can be kept in a decompressed state. In addition, a not-shown getter may be arranged in the inside of the vacuum chamber 10 so that the degree of vacuum can be kept.

The cathode 11 is an electron source, and is provided so as to oppose to the target layer 16. A hot cathode such as a tungsten filament and a dispenser cathode, or a cold cathode such as a carbon nanotube, for instance, can be used as the cathode 11. The grid electrode 12 and the lens electrode 13 are not indispensable elements, but can be provided so as to be capable of efficiently driving the radiation tube 6. The cathode electrode 11, the grid electrode 12 and the lens electrode 13 are electrically connected to the driving circuit 7, respectively, and predetermined voltages are applied to the electrodes, respectively. When the grid electrode 12 and the lens electrode 13 are arranged, a voltage Va to be applied between the cathode 11 and the target layer 16 is approximately 10 kV to 150 kV, though the voltage Va varies depending on an application in which the radiation is used.

When appropriate voltages are applied to the cathode 11, the grid electrode 12, the lens electrode 13 and the target layer 16, respectively, electrons are drawn from the cathode 11 by the electric field which is formed by the grid electrode 12. The drawn electrons are converged by the lens electrode 13, the converged electrons are incident on the target layer 16 of the target 9, and the radiation is thereby generated. The generated radiation permeates the supporting substrate 15 of the target 9, and is emitted to the outside of the radiation generating unit 2 further through the transmission window 4.

A diaphragm unit 3 is provided on the outside of the transmission window 4 which is provided in the storage container 5 of the radiation generating unit 2. The diaphragm unit 3 in the present exemplary embodiment includes an envelope 17 which surrounds the periphery of the transmission window 4, restriction blades 18 and a reflecting plate 19 which are provided in the inside of this envelope 17, and a light source 20 which is provided on the outside of the envelope 17. The reflecting plate 19 is provided between the restriction blades 18 and the transmission window 4.

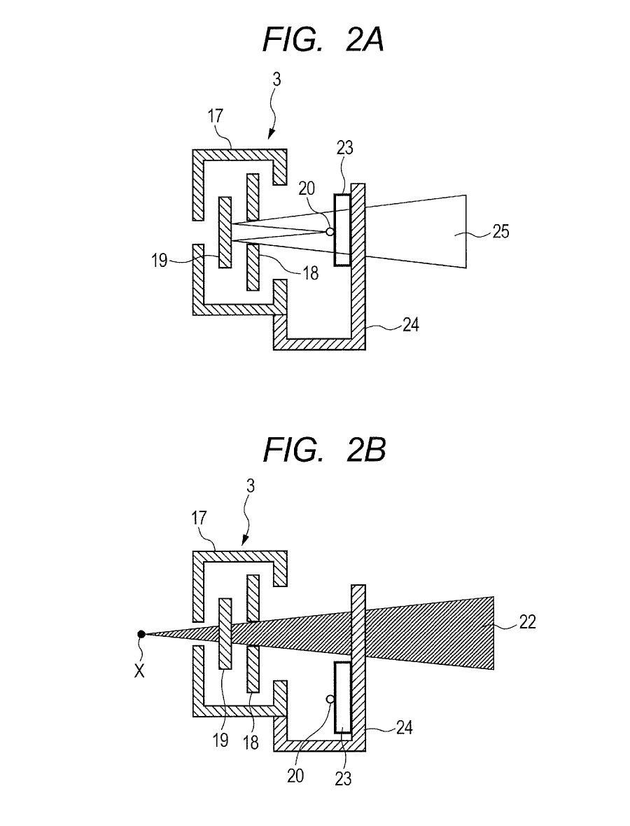

The restriction blades 18 are formed from a radiation shielding material, and forms the opening 21 which permits the passage of the radiation. The radiation which is emitted from the above described radiation generating unit 2 is emitted to the outside from this opening 21, and the radiation which has passed through the opening 21 forms the radiation field 22 (see FIG. 2B). The size of the opening 21 of the restriction blades 18 can be adjusted, and the size of the radiation field 22 can be adjusted by an operation of adjusting the size of the opening 21 of the restriction blades 18.

Such a mechanism can be used as the restriction blades 18 that two plate materials each having a notch or a hole, for instance, are overlapped so as to be capable of moving while sliding on each other so that the notches or the holes overlap with each other. In this case, the opening 21 is formed as the overlapped portion of the notches or the holes, and the size of this opening 21 can be adjusted by sliding the two plate materials on each other. In addition, such a mechanism can be used that a plurality of plate materials are overlapped while the positions are displaced so as to be capable of moving while sliding on each other so that the plate materials can form the opening 21 by surrounding the opening, or a mechanism also can be used which has a shutter-shaped structure of a camera.

The reflecting plate 19 is a member which reflects visible light thereon but transmits radiation therethrough, and for instance, can employ a glass plate which has a thin film of aluminum or the like provided on one face and consequently forms a reflecting surface. The reflecting plate 19 is provided so as to be perpendicular to a center line Z that is a straight line which connects a focus X of the radiation with the center Y of the opening 21 that is formed when the restriction blades 18 specify the maximum radiation field, and besides, so as to traverse an irradiation path of the radiation (shaded portion in FIG. 2B) which irradiates the radiation field 22 (see FIG. 2B). The focus X of the radiation means the center of a position on which the radiation is generated, and the center of the position that is irradiated with an electron beam on the target layer 16. In addition, the center Y of the opening 21 which is formed when the restriction blades 18 specify the maximum radiation field means a position corresponding to a position of the centroid of a virtual plate material which has the same shape and the same size as those of the opening that is formed when the restriction blades 18 specify the maximum radiation field and which has a uniform thickness.

As described above, the radiation tube 6 illustrated in the drawing is a transmitting type radiation tube, but in the present invention, a reflecting type radiation tube can be used. However, as described above, the reflecting plate 19 is positioned so as to be perpendicular to the center line Z, and accordingly does not have an action of reducing the heel effect in the reflecting type radiation tube, but can prevent a distribution of a radiation quality from being promoted when the transmitting type radiation tube has been used. For this reason, in the present invention, the radiation generating unit 2 can preferably be used which includes the transmitting type of radiation tube 6 therein as is illustrated.

The light source 20 is mounted on a transparent bed plate 23, and this bed plate 23 is structured so as to be capable of moving while sliding in a direction perpendicular to the center line Z along a supporting rail 24 which holds edges in both sides of the plate. The light source 20 can be moved between such a first position at which the light source 20 can simulatively show the radiation field 22 by the visible light field 25, and a second position which is displaced from an irradiation path of the radiation (shaded portion in the figure) which irradiates the radiation field 22, as is illustrated in FIGS. 2A and 2B. The above described first position is illustrated in FIG. 2A, and the above described second position is illustrated in FIG. 2B.

The above description will be more specifically described below. The light source 20 in the first position in FIG. 2A is positioned on the center line Z (see FIG. 1), and opposes to the reflecting surface of the reflecting plate 19 through the opening 21 of the restriction blades 18. A distance along the center line Z between the light source 20 and the reflecting surface of the reflecting plate 19 is equal to a distance along the center line Z between the focus X of the radiation and the reflecting surface of the reflecting plate 19. When the light source 20 emits light at such a position, the visible light field 25 can be formed which has approximately the same size and the same shape as those of the radiation field 22 that has been formed through the opening 21 of the restriction blades 18, which has the same size as that of the opening 21 set when the light source 20 emits light.

The light source 20 in the second position in FIG. 2B is in a position displaced from the irradiation path (shaded portion in the figure) of the radiation which irradiates the radiation field 22, and accordingly does not hinder irradiation with radiation. Accordingly, the radiation field 22 can be irradiated with the radiation without being influenced by the light source 20. Incidentally, the supporting rail 24 is provided at a position that is displaced from the irradiation path of the radiation which irradiates the radiation field 22.

An incandescent lamp, a halogen lamp, a xenon lamp, a light emitting diode (LED) and the like can be used as the light source 20, for instance, but a small-sized light source can preferably be used so as not to form a large shadow in the visible light field 25. Among them, the LED can preferably be used because of easily constituting a small-sized light source 20. When the light source 20 has a small size, the shadow of the light source 20 in the visible light field 25 can become unobtrusive. In addition, when the shadow of the light source 20 is positioned at the center of the visible light field 25, the shadow can show the center of the visible light field 25. The center of the visible light field 25 may also be shown by a cross line which is formed on the transparent bed plate 23 and is drawn by a light-shielding material. Thereby, the shadow of the light source 20 can be more unobtrusive.

The light source 20 in the present exemplary embodiment is mounted on the transparent bed plate 23, but can also be mounted on a bar-shaped arm or the like, which has such a thickness as not to hinder the formation of the visible light field 25, instead of using such a bed plate 23.

The envelope 17 is a member for shielding the radiation which has been reflected from the reflecting plate 19 and the restriction blades 18, for instance, and thereby preventing surplus exposure, and has an effect of shielding radiation. The envelope 17 can be formed from a material having the effect of shielding the radiation. A metal, for instance, such as lead, tungsten and tantalum, an alloy material thereof or the like, can be used as such a material. Alternatively, the envelope can be formed by using a metal such as aluminum and a synthetic resin which does not have a high radiation shielding effect so much, and by providing a metal sheet having a high radiation shielding effect thereon. Thereby, the radiation shielding effect can also be imparted to the envelope.

When the above described radiation generating apparatus 1 is used, the radiation field 22 is usually simulatively shown by the visible light field 25 prior to the irradiation with the radiation, and thereby is visually checked. This check is conducted by an operation of moving the light source 20 to the first position and making the light source 20 emit light, as is illustrated in FIG. 2A. The visible light which has been emitted from the light source 20 is reflected on the reflecting plate 19 through the opening 21 of the restriction blades 18, passes through the opening 21 again, and forms the visible light field 25. The opening 21 of the restriction blades 18 is adjusted in this state to fit a necessary size for the radiation field 22. After the size of the radiation field 22 has been determined, the light source 20 is moved to the second position illustrated in FIG. 2B while being slid together with the bed plate 23. After that, the radiation generating unit 2 is driven.

In the radiation generating unit 2, the electrons are drawn from the cathode 11 of the radiation tube 6 due to the electric field which is formed by the grid electrode 12, and fly toward the direction of the target 9. The flying electrons are converged by the lens electrode 13, collide with the target layer 16 of the target 9, and radiation is emitted. The radiation is emitted out from the transmission window 4 to the diaphragm unit 3. The radiation which has been emitted to the diaphragm unit 3 permeates through the reflecting plate 19, passes through the opening 21 of the restriction blades 18, and is emitted to a predetermined radiation field 22.

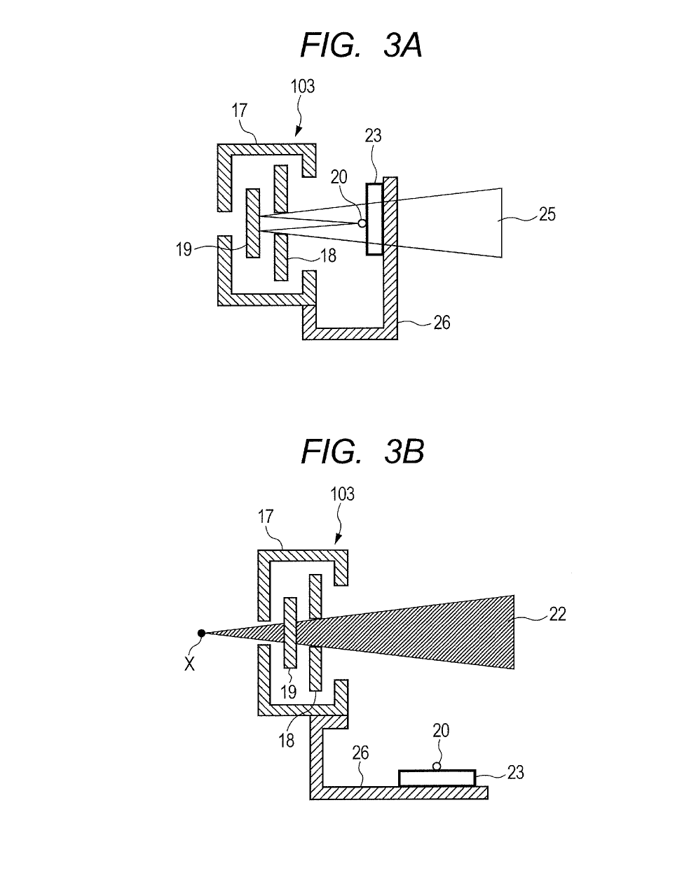

Next, a diaphragm unit 103 according to a second example will be described below with reference to FIGS. 3A and 3B. The diaphragm unit 103 in the present example is basically similar to the diaphragm unit 3 according to the first example which has been described with reference to FIG. 1, FIG. 2A and FIG. 2B. However, the present example is different from the first example in the point that the light source 20 is mounted on a tiltable supporting member 26. The light source 20 in the diaphragm unit 103 in the present example can be moved while being tilted between a first position illustrated in FIG. 3A and a second position illustrated in FIG. 3B, by an operation of tilting the supporting member 26. The first position and the second position are similar to each position in the first example.

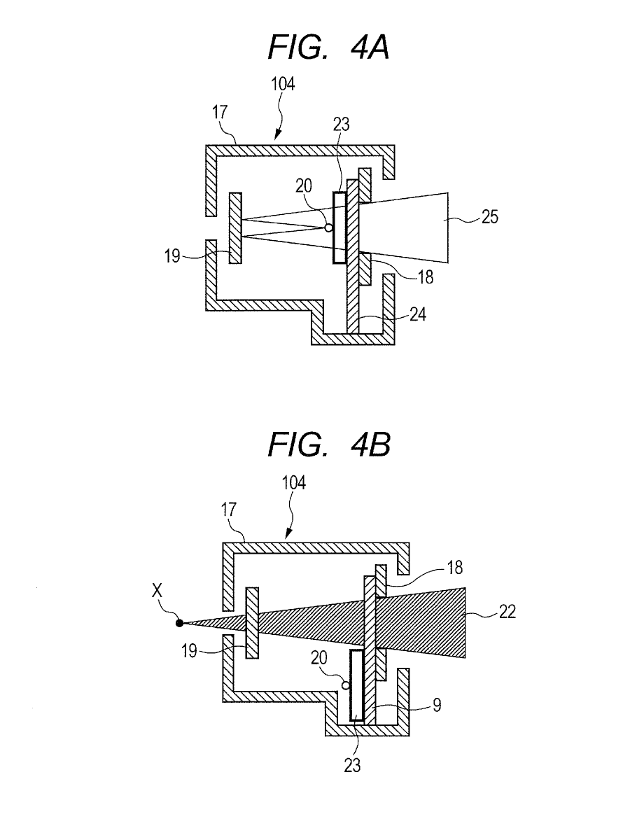

Furthermore, a diaphragm unit 104 according to the third example will be described below with reference to FIGS. 4A and 4B. The diaphragm unit 104 in the present example is similar to the diaphragm units 3 and 103 according to the first and second examples in that the restriction blades 18 and the reflecting plate 19 which is positioned between the restriction blades 18 and a transmission window 4 (see FIG. 1) are provided in the inside of the envelope 17. However, in the present example, the light source 20 is provided between the reflecting plate 19 and the restriction blades 18, and the light source 20 is also stored in the envelope 17. The light source 20 in the present example is mounted on a transparent bed plate 23, and this bed plate 23 is mounted on the envelope 17, and besides, is mounted so as to be capable of moving while sliding along a supporting rail 24 which is provided so as to be displaced from an irradiation path of the radiation which irradiates the radiation field 22. Specifically, the light source 20 in the present example is different from the light source 20 illustrated in FIG. 1, FIG. 2A and FIG. 2B in a point that the light source 20 is provided in the envelope 17, but is similar to the light source 20 illustrated in FIG. 1, FIG. 2A and FIG. 2B in a point that the light source 20 can move while sliding between a first position (FIG. 4A) and a second position (FIG. 4B). In the case of the diaphragm unit 104 in the present example, the envelope 17 cannot be downsized so much as that of the diaphragm unit 3, 103 according to the first example or the second example. However, the restriction blades 18 is arranged on the outside of the light source 20, and accordingly the image can be correctly simulatively shown even when the restriction blades 18 are arranged over the center line Z.

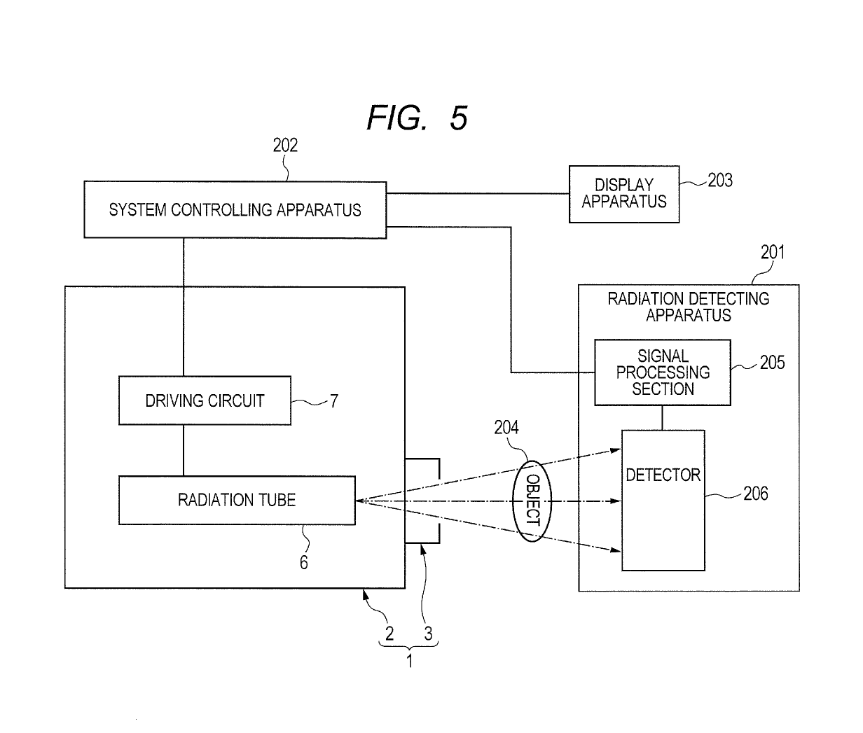

Next, one example of a radiation imaging system according to the present invention will be described below with reference to FIG. 5.

A system controlling apparatus 202 controls a radiation generating apparatus 1 and a radiation detecting apparatus 201 while coordinating them. A driving circuit 7 outputs various control signals to a radiation tube 6 under the control of the system controlling apparatus 202. The emission state of the radiation which is emitted from the radiation generating apparatus 1 is controlled by the control signal. The radiation which has been emitted from the radiation generating apparatus 1 permeates an object 204, and is detected by a detector 206. The detector 206 converts the detected radiation into an image signal, and outputs the converted image signal to a signal processing section 205. The signal processing section 205 subjects the image signal to predetermined signal processing under the control of the system controlling apparatus 202, and outputs the processed image signal to the system controlling apparatus 202. The system controlling apparatus 202 outputs a display signal for displaying an image on a display apparatus 203 to the display apparatus 203, based on the processed image signal. The display apparatus 203 displays the image based on the display signal on a screen, as a radiographed image of the object 204. A representative example of the radiation is an X-ray, and the radiation generating apparatus and the radiation imaging system of the present invention can be used as an X-ray generating apparatus and an X-ray imaging system. The X-ray imaging system can be used in a non-destructive test for an industrial product and in a pathological diagnosis for a human body and an animal.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-132870, filed Jun. 12, 2012, which is hereby incorporated by reference herein in its entirety.

### REFERENCE SIGNS LIST

1: Radiation generating apparatus, 2: Radiation generating unit, 3, 103 and 104: Diaphragm unit, 4: Transmission window, 5: Storage container, 6: Radiation tube, 7: Driving circuit, 8: Insulating liquid, 9: Target, 10: Vacuum chamber, 11: Cathode, 12: Grid electrode, 13: Lens electrode, 14: Shielding member, 15: Supporting substrate, 16: Target layer, 17: Envelope, 18: Restriction blades, 19: Reflecting plate, 20: Light source, 21: Opening, 22: Radiation field, 23: Bed plate, 24: Supporting rail, 25: Visible light field, 26: Supporting member, 201: Radiation detecting apparatus, 202: System controlling apparatus, 203: Display apparatus, 204: Object, 205: Signal processing section, 206: Detector

1. A radiation generating apparatus comprising:
a radiation generating unit which emits radiation, and a movable diaphragm unit which is arranged on the radiation generating unit,
wherein the movable diaphragm unit has restriction blades which adjust a size of a radiation field, a light source which emits visible light, and a reflecting plate which reflects the visible light thereon and transmits the radiation therethrough, and simulatively shows the radiation field in a form of a visible light field by the visible light,
wherein the light source can be moved between a first position at which the light source can simulatively show the radiation field by the visible light field, and a second position which is displaced from an irradiation path of the radiation which irradiates the radiation field.

2. The radiation generating apparatus according to claim 1, wherein the reflecting plate is arranged so as to be perpendicular to a center line which connects a focus of radiation and the center of an opening of the restriction blades.

3. The radiation generating apparatus according to claim 1, wherein the restriction blades and the reflecting plate which is positioned between the restriction blades and a radiation transmission window are provided in the inside of an envelope of the movable diaphragm unit, and the light source is provided on the outside of the envelope.

4. The radiation generating apparatus according to claim 1, wherein the restriction blades, the reflecting plate which is positioned between the restriction blades and a radiation transmission window and the light source which is positioned between the reflecting plate and the restriction blades are provided in the inside of an envelope of the movable diaphragm unit.

5. The radiation generating apparatus according to claim 3, wherein the light source is mounted on a tiltable supporting member and can move between the first position and the second position by an operation of tilting and moving the supporting member.

6. The radiation generating apparatus according to claim 3, wherein the light source can move between the first position and the second position by being slid in a direction perpendicular to the center line.

7. The radiation generating apparatus according to claim 1, wherein when the light source is in the first position, a distance between the focus of the radiation and a reflecting surface of the reflecting plate is equal to a distance between the reflecting surface of the reflecting plate and the light source.

8. The radiation generating apparatus according to claim 1, wherein the light source is mounted on a transparent bed plate and is moved together with the bed plate.

9. The radiation generating apparatus according to claim 1, wherein when the restriction blades are opened as the maximum, and the light source emits light in the first position to simulatively show the radiation field in a form of the maximum visible light field, a shadow of the light source is positioned in the center of the maximum visible light field.

10. The radiation generating apparatus according to claim 1, wherein the light source is a light emitting diode.

11. The radiation generating apparatus according to claim 1, wherein the radiation generating unit comprises a radiation tube which generates radiation, a driving circuit which controls the driving of the radiation tube, and a storage container which stores the radiation tube and the driving circuit therein and has a radiation transmission window.

12. The radiation generating apparatus according to claim 11, wherein a surplus space in the inside of the storage container is filled with an insulating liquid.

13. The radiation generating apparatus according to claim 11, wherein the radiation tube is a transmitting type.

14. The radiation generating apparatus according to claim 11, wherein the radiation tube comprises a vacuum chamber having a target mounted on a window part, and a cathode, a grid electrode and a lens electrode which are arranged in the vacuum chamber.

15. The radiation generating apparatus according to claim 14, wherein a shielding member which shields radiation is provided so as to surround the periphery of the target.

16. The radiation generating apparatus according to claim 14, wherein the inside of the vacuum chamber is decompressed to 10⁻⁴ Pa to 10⁻⁸ Pa.

17. A radiation imaging system comprising:
the radiation generating apparatus according to claim 1,
a detector which detects radiation that has been emitted from the radiation generating apparatus and has permeated an object, and
a system controlling apparatus which controls the radiation generating apparatus and the detector while coordinating them.
